(19) United States
(12) Patent Application Publication
(10) Pub. No.: US 2021/0171733 A1
(43) Pub. Date: Jun. 10, 2021

(54) RUBBER COMPOSITION FOR CUSHION RUBBER FOR REHABILITATED TIRES, AND A REHABILITATED TIRE USING THE SAME

(71) Applicant: TOYO TIRE Corporation, Itami-shi (JP)

(72) Inventor: Kento Dogomori, Itami-shi (JP)

(73) Assignee: TOYO TIRE Corporation, Itami-shi (JP)

(21) Appl. No.: 17/111,900

(22) Filed: Dec. 4, 2020

(30) Foreign Application Priority Data
Dec. 4, 2019 (JP) 2019-219225

(51) Int. Cl. C08K 5/47; C08K 5/31; C08L 7/00

(52) U.S. Cl. CPC C08K 5/47; B60C 2001/0075; C08L 7/00; C08K 5/31

(57) ABSTRACT

The present invention provides a rubber composition for cushion rubber for rehabilitated tire having a vulcanized speed being fast and a scorch resistance property being superior while being adaptable to environmental issues, as well as provides a rehabilitated tire having a durability. This rehabilitated tire may include a rubber composition for cushion rubber for rehabilitated tire which includes at least a rubber component comprising a diene rubber, di-2-benzothiazolyl disulfide and 1,3-diphenylguanidine, and a cushion rubber formed by vulcanizing the rubber composition for cushion rubber for rehabilitated tire.

### TECHNICAL FIELD

The present invention relates to a rubber composition for cushion rubber for rehabilitated tires, as well as a rehabilitated tire.

### BACKGROUND ART

As a method to remake a used tire, there is known a method in which a base tire is formed by grinding the tread rubber of a used tire, followed by displacing a cushion rubber on the base tire, followed by attaching a pre-cured tread to the cushion rubber, followed by heating the base tire equipped with the pre-cured tread by a vulcanization can. The cushion rubber can function to fix the pre-cured tread to the base tire.

Patent Reference 1 discloses a process for manufacturing a rubber composition which includes a step of kneading a diene type rubber and 1,3-diphenylguanidine to obtain a kneaded composition, and a step of kneading the kneaded composition, 2-mercaptobenzothiazole and a dithiocarbamate type accelerator having a benzene ring. The rubber composition thus prepared becomes a raw material of a cushion rubber for rehabilitated tires.

### REFERENCE OF BACKGROUND ART

### Patent References

Patent Reference No. 1: Japanese Laid-Open Patent Publication No. 2016-8286

### SUMMARY OF THE INVENTION

### The Objectives to Solve by the Invention

The effects of the technique disclosed by Patent Reference 1 are to accelerate a vulcanized speed of a rubber composition to become a raw material of a cushion rubber as well as to improve a scorch resistance property. However, it is expected that 2-mercaptobenzothiazole used in the technique disclosed by Patent Reference 1 could be refrained from use in view of the environmental issues.

The present invention was accomplished in view of the fact mentioned above, and therefore its purpose is to provide a rubber composition for cushion rubber for rehabilitated tire having a vulcanized speed being fast and a scorch resistance property being superior while being adaptable to environmental issues, as well as to provide a rehabilitated tire having a durability.

### Means to Solve the Objectives

The objectives as explained above can be solved by a rubber composition for cushion rubber for rehabilitated tires which includes a rubber component including a diene type rubber, di-2-benzothiazolyl disulfide and 1,3-diphenylguanidine, as well as a rehabilitated tire provided with a cushion rubber formed by vulcanizing the rubber composition for cushion rubber for rehabilitated tires.

The rubber composition for cushion rubber for rehabilitated tires of the present invention has a vulcanized speed being fast and is superior in the scorch resistance property. In addition, the rehabilitated tire of the present invention has a high torque value and a high breaking strength, and is superior in the durability.

### EMBODIMENTS TO CARRY OUT THE INVENTION

The rubber composition for cushion rubber for rehabilitated tires of the present invention includes a rubber component comprising a diene type rubber, di-2-benzothiazolyl disulfide and 1,3-diphenylguanidine.

The examples of the diene type rubber can include natural rubber (NR), polyisoprene rubber (IR), polybutadiene (BR), polystyrene-butadiene rubber (SBR), chloroprene rubber (CR) and nitrile rubber (NBR), etc. In particular, it is preferable to use a natural rubber (NR), polybutadiene rubber (BR) and polystyrene-butadiene rubber (SBR). Also, the other rubber component ingredient than the diene type rubber can be added. When a total quantity of the rubber component is assumed to be 100 parts by mass, it is preferable to include the diene type rubber at a quantity of 80 parts by mass or more, and it is more preferable to include it at a quantity of 90 parts by mass or more, and it is yet more preferable to include it at a quantity of 100 parts by mass.

The di-2-benzothiazolyl disulfide and the 1,3-diphenylguanidine can act as a vulcanization accelerator. When a total quantity of the rubber component is assumed to be 100 parts by mass, it is preferable that the content of the di-2-benzothiazolyl disulfide is 0.1 to 3.0 parts by mass, and it is more preferable that it is 0.5 to 2.0 parts by mass. When a total quantity of the rubber component is assumed to be 100 parts by mass, it is preferable that the content of the 1,3-diphenylguanidine is 0.02 to 6.0 parts by mass, and it is more preferable that it is 0.1 to 4.0 parts by mass.

It is preferable to adjust a mass ratio of the di-2-benzothiazolyl disulfide and the 1,3-diphenylguanidine. In details, when a blending amount of the 1,3-diphenylguanidine is W(D) and a blending amount of the di-2-benzothiazolyl disulfide is W(DM), it is preferable to satisfy 0.2≤W(D)/W(DM)≤2.5, and it is more preferable to satisfy 0.2≤W(D)/W(DM)≤2.0, and it is yet more preferable to satisfy 0.7≤W(D)/W(DM)≤2.0, and it is more preferable to satisfy 1.0≤W(D)/W(DM)≤1.5.

Additional vulcanization accelerator other than the di-2-benzothiazolyl disulfide and the 1,3-diphenylguanidine can be used together. The examples of such additional vulcanization accelerator can include a sulfenamide type vulcanization accelerator, a thiram type vulcanization accelerator, a thiazole type vulcanization accelerator, a thiourea type vulcanization accelerator, a guanidine type vulcanization accelerator, and a dithiocarbamate type vulcanization accelerator, etc. However, in view of adapting it to the environmental issues, the blending amount of the 2-mercaptobenzothiazole in the rubber compositions is preferably 1 part by mass or less, and more preferably 0.5 parts by mass or less, and yet more preferably 0.1 parts by mass or less, when a total quantity of the rubber component is assumed to be 100 parts by mass. It is further preferable that the 2-mercaptobenzothiazole is not included in the rubber composition.

The rubber composition for cushion rubber for rehabilitated tires of the present invention can include additional agent in addition to the rubber component, di-2-benzothiazolyl disulfide and 1,3-diphenylguanidine. The examples of such additional agent can include carbon black, silica, a silane coupling agent, a vulcanized type agent, an antioxidant, zinc oxide, stearic acid, a wax, a softener such as oil, and a processing aid.

The examples of the carbon black to be used can include carbon black such as SAF, ISAF, HAF, FEF and GPF, etc., and a conductive carbon black such as acetylene black and ketjen black, etc. In the rubber composition for cushion rubber for rehabilitated tires, it is preferable to blend a carbon black at an amount of 10 to 120 parts by mass, and more preferable to blend it at an amount of 20 to 100 parts by mass, with respect to 100 parts by mass of the diene type rubber.

The examples of the silica to be used can include wet process silica, dry process silica, sol-gel silica, and surface treated silica, etc. In particular, it is preferable to use wet process silica.

The examples of the silane coupling agent to be used can include one including sulfur in its molecule. For example, the examples thereof can include; a sulfide silane such as bis(3-triethoxysilylpropyl) tetrasulfide (for example, “Si69” manufactured by Degussa AG Corporation), bis(3-triethoxysilylpropyl) disulfide (for example, “Si75” manufactured by Degussa AG Corporation), bis(2-triethoxysilylethyl) tetrasulfide, bis (4-triethoxysilylbutyl) disulfide, bis(3-trimethoxysilylpropyl) tetrasulfide, and bis(2-trimethoxysilylethyl) disulfide; and a protected mercaptosilane such as γ-mercaptopropyl trimethoxy silane, γ-mercaptopropyl triethoxy silane, mercaptopropylmethyl dimethoxy silane, mercaptopropyl dimethyl methoxysilane, a mercaptosilane such as mercaptoethyl triethoxy silane, 3-octanoylthio-1-propyl triethoxy silane and 3-propionylthio propyl trimethoxy silane.

The examples of the antioxidant can include an aromatic amine type antioxidant, an amine ketone type antioxidant, a monophenol type antioxidant, a bisphenol type antioxidant, a polyphenol type antioxidant, a dithiocarbamate type antioxidant, and a thiourea type antioxidant, etc. These antioxidants can be used alone or in an appropriate combination thereof.

The examples of the vulcanization type agent can include a vulcanization agent such as sulfur and an organic peroxide, a vulcanization acceleration assistant agent, and a vulcanization delay agent, in addition to the vulcanization accelerator mentioned before.

The sulfur as a vulcanization type agent can be sulfur for rubbers, and the examples thereof can include powdery sulfur, sedimentation sulfur, insoluble sulfur, high dispersibility sulfur, etc.

The rubber composition for cushion rubber for rehabilitated tires of the present invention can be obtained through a blend work on the rubber component, di-2-benzothiazolyl disulfide and 1,3-diphenylguanidine, along with adding ones appropriately selected from the group consisting of, for example, carbon black, silica, a silane coupling agent, a vulcanization type agent, an antioxidant, zinc oxide, stearic acid, wax, a softener such as oil, and a processing aid, by means of a blending kneader used in rubber industries such as a Banbury Mixer, a kneader and a roll.

Also, for example, a blending method of each component as mentioned above can be carried out by making in advance a master batch by blending and kneading blending components except for a vulcanization type agent such as a sulfur type vulcanization agent and a vulcanization accelerator, followed by adding the remaining components therein to continue further kneading. Alternatively, each component can be added and kneaded in an arbitrary order, or all the components can be added and kneaded at the same time.

The rubber composition for cushion rubber for rehabilitated tire can become a raw material for a cushion rubber to constitute a rehabilitated tire. The rehabilitated tire can be manufactured by a pre-curing method. For example, with an intervention of an unvulcanized cushion rubber formed of the rubber composition for cushion rubber for rehabilitated tire in a shape, a base tire is attached to a pre-cured tread, which is then heated and vulcanized in a vulcanization can, thereby manufacturing a rehabilitated tire. In case when a rehabilitated tire is produced by a pre-cure method, it is characterized in heating it at a low temperature for a long time to carry out vulcanization, but the rubber composition for cushion rubber for rehabilitated tires of the present invention has a vulcanization speed being fast and is superior in the scorch resistance property, and therefore, it is especially useful to be used as a raw material of a cushion rubber in producing rehabilitated tires by means of a pre-cure method.

### EXAMPLES

Hereinafter, the examples are explained.

### (1) Maximum Torque (MH) and Vulcanization Speed (T90) in a Vulcanization Behavior Measurement Test of an Unvulcanized Rubber Composition by Means of a Rheometer:

In accordance with JIS K6300-2: 2013, a maximum torque (MH) and a vulcanization speed (T90) were measured in a vulcanization behavior measurement test of an unvulcanized rubber composition. T90 is a time (minute) from the start of the measurement to reach a torque of 90% of (MH-ML), assuming that the maximum value of the torque is MH and the minimum value thereof is ML, in a vulcanization behavior measurement experiment test of an unvulcanized rubber composition by means of a rheometer. In each evaluation, it is expressed by an index evaluation when Comparative Example 1 is assumed to be 100. As the index of MH is higher, it means that the torque is larger. As the index of T90 is smaller, it means that the vulcanization speed is faster.

### (2) Scorch Resistance Property (Scorch Time t5)

In accordance with JIS K6300, a rotorless Mooney measurement machine manufactured by Toyo Seiki Manufacturing Co. Ltd. was used to measure a time t5 to increase a 5 Mooney unit from the lowest viscosity Vm after preheating an unvulcanized rubber composition at 125° C. for one minute. Assuming that a value of Comparative Example 1 is 100, and those of Comparative Example 2 and Example 1 were expressed by an index. As the value becomes bigger, it means that the scorch time becomes longer and it is superior in the scorch resistance property.

### (3) Break Strength

A rubber sample was prepared by vulcanizing an unvulcanized rubber sheet of the Examples and the Comparative Examples at 120° C. for 30 minutes. In accordance with JIS K6251, a tensile test (Dumbbell Type No. 3) was carried out to measure a tensile strength of the rubber sample. The evaluation results of the break strength were expressed by an index, assuming that the values of the tensile strength of Comparative Examples 1 and 2 are 100. As its value becomes larger, it means that it was superior in the break strength.

Preparation of Rubber Composition

In accordance with the blending prescription shown in Table 1, each of the rubber compositions of Example 1 and Comparative Examples 1-2 were provided. Using a Banbury Mixer for kneading, the rubber compositions were prepared. Each of the agents described in Table 1 are explained below. In Table 1, the blending amount of each agent is based on parts by mass with respect to 100 parts by mass of the rubber component.

a) The natural rubber (NR) is RSS #3;
b) The styrene butadiene rubber (SBR) is NIPOL 1502 manufactured by Zeon Corporation;
c) The butadiene rubber (BR) is UBEPOL BR150B manufactured by Ube Industries Corporation;
d) The carbon black 1 is Show Black N326 manufactured by Cabot Japan Corporation;
e) The carbon black 2 is Show Black N330T manufactured by Cabot Japan Corporation;
f) The stearic acid is stearic acid manufactured by NOF Corp.;
g) The zinc oxide is the second type of zinc oxide manufactured by Mitsui Mining And Smelting Company;
h) The antioxidant is NOCRAC 6C manufactured by Ouchi Shinko Chemical Industrial Co., Ltd.;
i) The oil is Process P200 manufactured by JX Nippon Oil & Energy Co., Ltd.;
j) The adhesion addition agent is ESCOLETS 1102 manufactured by Exxon Mobil Corp.;
k) The sulfur is powdery sulfur manufactured by Tsurumi Chemical Industry Co., ltd.;
l) Vulcanization accelerator DM (di-2-benzothiazolyl disulfide) is NOCCELER DM manufactured by Ouchi Shinko Chemical Industrial Co., Ltd.;
m) Vulcanization accelerator M (2-mercaptobenzothiazole) is NOCCELER M manufactured by Ouchi Shinko Chemical Industrial Co., Ltd.:
n) Vulcanization accelerator DPG (1,3-diphenylguanidine) is NOCCELER D manufactured by Ouchi Shinko Chemical Industrial Co., Ltd.:
o) Vulcanization accelerator PZ (dimethyl dithiocarbamic acid zinc) is NOCCELER PZ manufactured by Ouchi Shinko Chemical Industrial Co., Ltd.;
p) Vulcanization accelerator ZTC (dibenzyl dithiocarbamic acid zinc) is NOCCELER ZTC manufactured by Ouchi Shinko Chemical Industrial Co., Ltd.; and
q) VULKALENT is VULKALENT E/C manufactured by Lanxess Corporation.

TABLE 1

| | | Comp 1 | Comp 2 | Ex. 1 | Ex. 2 |
|---|---|---|---|---|---|
| First | NR | 100 | 100 | 100 | 100 |
| blend | SBR | — | — | — | — |
| | BR | — | — | — | — |
| | Carbon | 25 | 25 | 25 | 25 |
| | Black 1 | | | | |
| | Carbon | 15 | 15 | 15 | 15 |
| | Black 2 | | | | |
| | stearic acid | 2 | 2 | 2 | 2 |
| | zinc oxide | 3 | 3 | 3 | 3 |
| | antioxidant | 3 | 3 | 3 | 3 |
| | oil | 15 | 15 | 15 | 15 |
| | adhesion | 5 | 5 | 5 | 5 |
| | addition | | | | |
| | agent | | | | |
| | DPG | — | 0.3 | — | — |
| Final | sulfur | 3 | 3 | 3 | 3 |
| blend | D (DPG) | 0.3 | — | 0.7 | 0.5 |
| | DM | — | — | 0.5 | 0.7 |
| | M | 0.5 | 0.5 | — | — |
| | PZ | 0.4 | — | — | — |
| | ZTC | — | 0.8 | — | — |
| | VULKALENT | 0.1 | 0.1 | 0.1 | 0.1 |
| | W(D)/W(DM) | — | — | 1.4 | 0.7 |
| Evaluated | MH | 100 | 100 | 105 | 101 |
| property | | | | | |
| Evaluated | Scorch time | 100 | 110 | 110 | 109 |
| property | t5 | | | | |
| Evaluated | T90 | 100 | 89 | 87 | 90 |
| property | | | | | |
| Evaluated | Break | 100 | 100 | 107 | 103 |
| property | strength | | | | |
| | | Ex. 3 | Ex. 4 | Ex. 5 | Ex. 6 |
| First | NR | 100 | 80 | 80 | 80 |
| blend | SBR | — | 20 | — | 10 |
| | BR | — | — | 20 | 10 |
| | Carbon | 25 | 25 | 25 | 25 |
| | Black 1 | | | | |
| | Carbon | 15 | 15 | 15 | 15 |
| | Black 2 | | | | |
| | stearic acid | 2 | 2 | 2 | 2 |
| | zinc oxide | 3 | 3 | 3 | 3 |
| | antioxidant | 3 | 3 | 3 | 3 |
| | oil | 15 | 15 | 15 | 15 |
| | adhesion | 5 | 5 | 5 | 5 |
| | addition agent | | | | |
| | DPG | — | — | — | — |
| Final | sulfur | 3 | 3 | 3 | 3 |
| blend | D (DPG) | 0.8 | 0.7 | 0.7 | 0.7 |
| | DM | 0.4 | 0.5 | 0.5 | 0.5 |
| | M | — | — | — | — |
| | PZ | — | — | — | — |
| | ZTC | — | — | — | — |
| | VULKALENT | 0.1 | 0.1 | 0.1 | 0.1 |
| | W(D)/W(DM) | 2 | 1.4 | 1.4 | 1.4 |
| Evaluated | MH | 102 | 102 | 104 | 103 |
| property | | | | | |
| Evaluated | Scorch time | 106 | 113 | 111 | 112 |
| property | t5 | | | | |
| Evaluated | T90 | 93 | 91 | 89 | 90 |
| property | | | | | |
| Evaluated | Break | 102 | 103 | 105 | 104 |
| property | strength | | | | |

The results in Table 1 show that the rubber composition of Example 1 had a vulcanization speed being fast and was superior in the scorch resistance property. In addition, its vulcanized rubber had a high torque and a high break strength, finding that it was superior in the durability.

It is preferable that the MH of the rubber composition of the present invention is higher than that of Comparative Example 1 (i.e., MH=100), and is more preferable in a range of 101 and 120 from, and yet more preferable in a range of 101 and 105. As shown in Table 1, the MH of the rubber composition of the Examples is higher than that of Comparative Example 1, thereby meaning that it had a large torque.

The T90 of the rubber composition of the present invention is preferably smaller than that of Comparative Example 1 (i.e., T90=100), and more preferably in a range of 99 or less, and yet more preferably in a range of 70 to 90, and furthermore preferably in a range of 87 to 93. As shown in Table 1, T90 of the rubber compositions of the Examples were smaller than that of Comparative Example 1, meaning that it had a vulcanized speed being fast.

What is claimed is:

1: A rubber composition for cushion rubber for rehabilitated tires, comprising: a rubber component comprising a diene rubber, di-2-benzothiazolyl disulfide and 1,3-diphenylguanidine.

2: The rubber composition for cushion rubber for rehabilitated tires according to claim 1, wherein assuming that a blending amount of the 1,3-diphenylguanidine is W(D) and a blending amount of the di-2-benzothiazolyl disulfide is W(DM), the rubber composition for a cushion rubber for a rehabilitated tire satisfy 0.2≤W(D)/W (DM)≤2.0.

3: A rehabilitated tire, comprising a cushion rubber formed by vulcanizing the rubber composition for cushion rubber for rehabilitated tire according to claim 1.

4: A rehabilitated tire, comprising a cushion rubber formed by vulcanizing the rubber composition for cushion rubber for rehabilitated tire according to claim 2.
